(19) United States
(12) Patent Application Publication
(10) Pub. No.: US 2008/0144934 A1
(43) Pub. Date: Jun. 19, 2008

(54) PROCESS FOR THE ANALYSIS OF THE POSITIONING OF PRODUCTS ON STORE SHELVES

(76) Inventor: Jean-Philippe RAYNAUD, Paris (FR)

Correspondence Address: MOETTELI & ASSOCIATES SARL, ST. LEONHARDSTRASSE 4, ST. GALLEN, CH-9000, omitted

(21) Appl. No.: 11/943,668

(22) Filed: Nov. 21, 2007

(30) Foreign Application Priority Data
Nov. 23, 2006 (FR) FR 06/10269

(51) Int. Cl. G06K 9/34

(52) U.S. Cl. 382/173

(57) ABSTRACT

The invention concerns a method for the analysis of the positioning of products on shelves based on a digital photograph of at least a part of the shelves. Each product to be analyzed is predefined by a signature of visual characteristics of the product. The method includes the steps of dividing of the digital photograph in zones including visually identical products, and, for at least one zone, comparing the visual characteristics of the zone with the signatures of products. The comparison is based on a proximity metric of visual characteristics of the zone with the signatures of products. Finally, the determination is made as to which product(s) belonging to the zone are products having a signature minimizing the proximity metric.

### FIELD OF THE INVENTION

The present invention concerns a process and a system for the analysis of the positioning of products on the shelves of a store and a computer program for implementing the process. It concerns the data structure representative of a photograph.

### BACKGROUND OF THE INVENTION

In the field of merchandizing, companies that produce products of mass consumption place particular importance on the placement of their products at point of sale. In particular, they seek the best visibility possible of the products on store shelves, or lineaires, in order that their products attract the eye of consumers and initiate a purchase decision. Often, the installation of the products on the store shelves is determined in the contract clauses between the manufacturers and the vendors.

To verify this placement of products, the companies usually ask their sales teams, or their subcontractors, to prepare a statement of the actual placement determined during a visit of the team members to the sellers.

These manually created statements are time consumers and are subject to numerous errors during the statement or the transmission of the statement to the analysis teams responsible for such.

In order to automate this task, French patent application FR 2851 833 proposes that the vendors be satisfied with taking a digital photo of the zone of the shelving concerned during the visit to the store. Then this photograph is transmitted, via a data network, to an image processing center. This image processing center determines the linear of shelving of the product by measuring the linear of shelving on the digital photograph, then, the information obtained is transmitted to an analysis center providing likewise all the pertinent information concerning the positioning of these products on the shelves of the vendor as well as the information on the products of competitors, thereby permitting him to better understand the competitive landscape.

Likewise, the time spent by the sales teams to prepare the statement of placement of the products is reduced to taking the photographs.

The processing of the images, in the patent application aforementioned, is preformed either manually, that is to say that an operator visually locates on the photograph the sought products, then measures the shelves, either automatically by utilizing a form and color recognition algorithm. This algorithm is based on the extraction of pertinent points by a Harris detector, the indexing and the special searching of the colors by the Hilbert invariants.

Both the usage of manual processing or totally automatic processing presents several inconveniences.

Concerning manual processing, the operator must remember a long list of visual characteristics of the products. Likewise, with the products having very similar visual characteristics, sometime photographs of mediocre quality, and a large list of products, the detection by an operator of the correct product corresponding to the photograph may take a half an hour. Even though the time may be reduced in principle through thorough training of the operator, the large number of products and the continuous change in packaging makes this training difficult.

For automatic processing, the principal difficulty derives from the large number of variations in photograph quality of the shelving zones taken by the operator, the lighting in the store, etc, while, on the other hand, the product photographs making up the reference product data base are taken in a studio under perfect viewing conditions. Likewise, for example, the color of the photograph of the product does not correspond to the color of the image of the same photograph taken by the vendor in the aisles of the supermarket. What's more, as is well known, the products are often manipulated by the clients of the store and therefore may be displaced in a manner that they do no expose their front face, often referred to as “facing”, well aligned along the shelf. Further, automatic processing must account for the poor “facing”, the fact that the reference images do not exist in the database, as well as the “facing” that are similar but in different conditions, or that visual obstacles hide the “facings”.

All these elements make automatic processing very complex. In addition, experience has shown, that its state of the art, and in particular by using local analytical algorithms of the known image by the aforementioned document, the level of success in automatic processing is relatively low despite the significant amount of calculations involved.

It is therefore desirable to provide a process for the processing of images which optimizes the significant calculation power while having a rate of success in product recognition that approaches 100%, that is to say, is robust compared to the quality of viewing limitations of products seen in stores.

It is likewise desirable to provide a method of image processing which permits the intervention of an operator during intermediate steps, either for correcting the results of a previous step, or for accelerating the processing.

Finally, to deal as well as possible with one or more of these concerns, in a characteristic of the invention, a process for the analysis of the placement of products in the linear of shelving from a digital photograph of at least a part of the shelving, each product for analysis being previously defined by a signature of the visual characteristics of such, comprises among other things the following steps:
dividing the digital photo in zones comprising products which are visually identical, and
for at least one zone,
comparing the visual characteristics of the zone with the signature of products, the comparison being based on a proximity metric of visual characteristics of the one with the signatures of products, and
determination of where the products appear in the zone to the extent that the products have a signature which minimizes the proximity metric. According to another aspect of the invention, a computer program product downloadable from a communications network and/or installed on a computer readable support and/or executable by a processor, includes computer encoded program instructions for implementing the method of aforementioned analysis.

According to another aspect of the invention, a data structure representative of a photograph comprises data fields representative of the zones of the photograph, each field allowing the definition of the visual characteristics of the zone adapted for being compared with the signatures of the products in the form of a proximity metric of visual characteritics of the zone with the signatures of products.

According to another aspect of the invention, the system for the analysis of the placement of products on shelving from a digital photo or at least a part of the shelving, each product to be analyzed being previously defined by a signature of visual characteristics of such, comprises:
a means of storage of the signatures of the said products,
a means of dividing the digital photo into zones comprising visually identical products, and
for at least one zone,
means for comparing the visual characteristics of the zone with the signatures of products, the comparison being based on a proximity metric of the visual characteristics of the zone with the signatures of the products, and
a means for determining where the products appearing in the zone and the products having a signature minimize the proximity metric.

Other characteristics and particular modes of execution are described in the appended claims.

### BRIEF DESCRIPTION OF THE DRAWINGS

The invention is best understood by reading the following description, provided by way of example only, and make reference to the attached figures in which:

FIG. 1 is a schematic view of a system for the analysis according to one mode of execution of the invention;

FIG. 2 is a logical flow diagram of a method according to the invention; and

FIG. 3 is a schematic view of an analysis device according to a mode of execution of the invention.

### DETAILED DESCRIPTION OF THE PREFERRED EMBODIMENT(S)

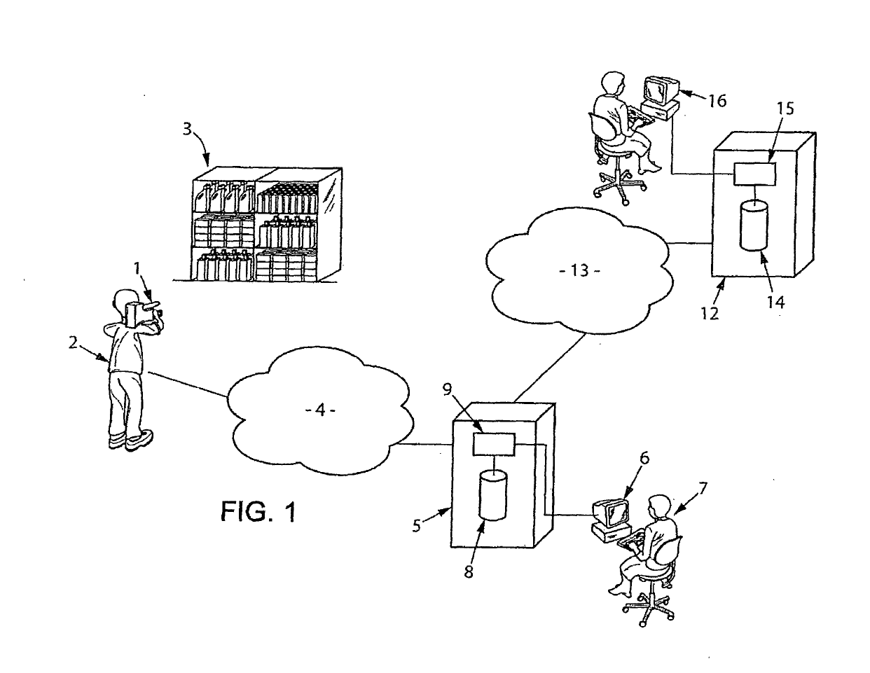

Referring to FIG. 1, a complete analysis system comprises a digital camera 1 manipulated by an operator 2 for taking photographs of the shelves 3 of a store. The operator 2 is, for example, a sales agent of the manufacturer, a subcontractor or an employee of the distributor.

A data network 4 permits the transmission of digital photographs, in the form of files, of a camera 1 to an image processing server 5.

The image processing server 5 comprises a console 6 serving as an interface between the user interface and the machine with a process operator 7.

It comprises as well a data base 8 containing the visual characteristics of all the products for study. It is noted that this database 8 is not limited only to the products of the manufacturer in an effort to know the disposition of his products, rather a gathering of the products of all the manufacturers in the concerned markets. In effect, this entity is often also very interested to know this type of information of competitor's products. Also, in the given domain, for example hair products, the data base 8 may contain several tens of thousands of references.

The visual characteristics of each product are previously extracted from photographs of the product. In these photographs, often taken in studios, the product is isolated from its environment, in a packaging in perfect condition. What's more, the photograph is perfectly framed for presenting the front face of the product, even though, sometimes, additional photographs showing another face of the product are included in the file. One understands therefore that by “visual characteristic of the product”, one refers to the product in its packaging as it is at the point of sale, possibly placed on or in a display device.

The server 5 comprises among other things the calculation means 9 permitting the digital image processing.

The image processing server 5 is connected to an analysis server 12 by a data network 13. The data network 13, as with the data network 4, is a typical network, like, for example, the Internet, a VPN private virtual network or a public telephone network.

The analysis server 12 comprises the means of storage 14, for example a database, the results of the image processing of the different photographs taken, of a statistical analysis means 15 of these results and the presentation means 16 of the statistical analysis.

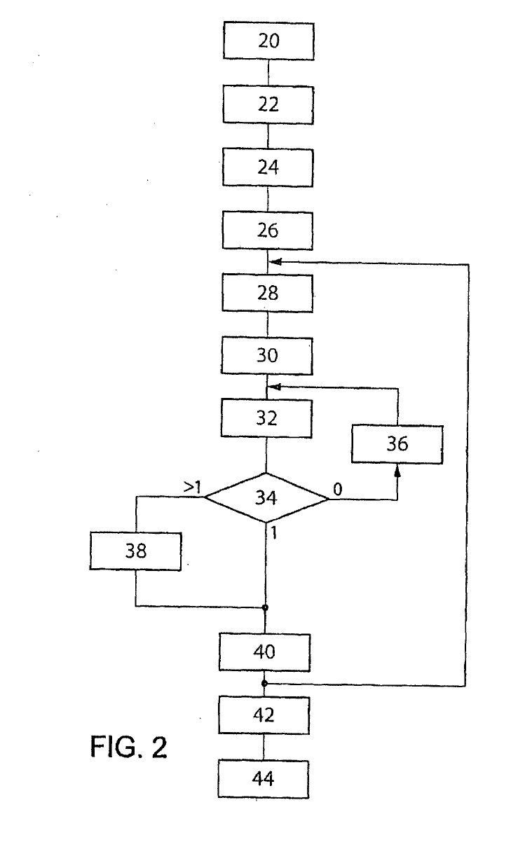

The function of the system is the following, FIG. 2.

In a previous step 18, the data base of the server 5 is populated with the visual characteristics of the products, or, more precisely, the packaging of the products as they are presented at the point of sale.

The visual characteristics of the products are extracted from those photographs.

They comprise two large categories:
the global visual characteristics that is to say those which concern the totality of the product without distinction as to the visual zone, and
special visual characteristics, or local, that concern particular zones of the product or the relation between particular zones.

The global visual characteristics are developed by calculating a vector of which the components are represented by the characteristics of discrete signals extracted from the image. For example, they regroup the colorimetric characteristics of the image of the product, and in a first place, its chrominance. This corresponds to the average color of the image. In the traditional breakdown of the colors in three primary colors red, green, and blue, traditional encoding called RVB, which corresponds amongst themselves to the ratio of the primary colors. In processing the digital images, this chrominance is traditionally encoded in 24 or 32 bits for obtaining a colormetric depth preserving the natural variety of colors.

Other than chrominance, the global visual characteristics may likewise comprise the first moment of a labeled palette color histogram and a labeled color palet autocorrelogram, this autocorrelogram describing the neighboring colors amongst themselves.

The spacial visual characteristics are particularly represented by a spatial chromatic histogram (in English SCH for Spatial Chromatic Histogram) which defines the relative position of the colors, for example, that the red is found primarily at the bottom and to the right of the image. A complete description of the usage of this type of histogram is found in L. Cinque et al, “Color-based Image Retrieval Using Spatial-Chromatic Histograms, Proceedings of the IEEE International Conference on Multimedia Computing and Systems Volume II-Volume 2-Volume 2, p. 969, 1999. The spatial chromatic histogram takes advantage of a labeled color palet, permitting as well a more relevant processing of the colors according to their perception in lighting of varying quality.

The totality of the global visual characteristics determines a signature of the product in that it visually characterizes and discriminates one product from other products. This signature is, for example, a hash value of the visual characteristics vector and is therefore comprised of a unique digital value. In a preferred manner, the calculation of this signature considers the visual proximity of the images in the sense in which two images having similar visual characteristics likewise have similar signatures of the sort that the signature may serve as a metric of the visual proximity of the images.

In one mode of execution, the database 8 of the products is a relational data base and this signature is used for creating an index of the database.

The operator 2 takes in step 20, one or more digital photographs of the portion of the linear 3 of shelves of interest. It should be noted that the taking of photographs may use film-based photography which are subsequently digitized.

The digital photographs are sent in step 22 to the image processing server 5 by the data network 4.

Having arrived at the image processing server 5, the photographs are submitted to a first preliminary processing 24 mainly consisting of a balancing of whites in a manner to minimize the fluctuations of the quality of the photographs depending on the condition of viewing. Different well-known techniques well known to the person of ordinary skill in the field may be used for this. Most precisely, they base themselves on a calibration sample placed in the field of view by the operator 2 during the taking of the photograph. Other techniques use the dominant colors of the photograph. The latter techniques must be used with caution in the described process to the extent that the dominant of one color may come exactly from the color most used by the product or the range of products present in the photographed linears of shelves. The assistance of the operator 11 proves then necessary to obtain the result which approaches optimal conditions.

Other preparatory treatments may also be used like, for example, a geometric regression of the photograph permitting the representation of the linear of shelving in a front view without deformation.

Then the photograph is divided in step 26 in homogeneous zones regrouping products which are visually identical.

This division is more often rectangular due to a traditional disposition of the linears in shelves superimposed on which the products are placed. It may be implemented by the operator 11 by using the selection tools of the image processing software or by a classic automatic processing based on the visual homogeneity of the zone.

Then each zone is separately processed with the objective of determining which is the visible product in the zone.

For the zone under analysis, the chrominance and the palette histogram of which are calculated in step 28.

By using the same method of calculation as for the products, the chrominance and the palette histogram generates the signature of the zone under analysis in step 30.

This signature of the zone is compared in step 32 with signatures of the products contained in the data base 8. The signature having been constituted in a manner that two close signatures correspond to two images having close global visual characteristics, it is possible to define a metric defining the proximate distance between two images. The comparison consists of researching the product(s) of which the signature is the closest to that of the zone under analysis according to the metric.

The use of a relational data base indexed to the signature permits an extremely rapid extraction of the registrations minimizing this metric from the database.

Following this comparison, zero, one or several products are extracted in step 34 and considered as being visually close to the zone under analysis. Indeed, the signatures of zones being rarely perfectly identical to those of a product, one defines a threshold of proximity below which the distance between signatures is considered as sufficiently close so that the corresponding product is potentially the product photographed in the zone.

If no product is found, the comparison step 32 is relaunched by adding in step 36 the threshold of proximity until that at which at least one product is extracted.

If several products are extracted in step 34, a sequential comparison based on the spatial chromatic histograms is effected in step 38 in order to extract the product corresponding to the zone under analysis.

Likewise, either directly after signature comparison step 32, or after spatial chromatic histogram comparison step 38, a unique product is defined in step 40 as being the product represented by the zone under analysis.

A bijection having been effected between the zone and the product and this operation having been renewed for all the zones of interest of the photograph, the characteristics are principally the length of the shelf occupied by the product as well as the positioning of the product in the linear of shelving.

These characteristics are sent in step 44 to the analysis server 12 in order to be statistically processed and presented in an output interface to the persons concerned.

These steps are steps are executed in a classical manner as described, for example, in the aforementioned patent application.

One has also described a method of analysis which allows for a good level of correspondence of the product with the zone of the photograph all while requiring that the numerical processing be relatively low consumers of processing power.

The process described proves to be particularly robust to variations in the quality of photographs taken in stores.

The person of ordinary skill in the art knows how to inplement variations according to the descriptions of these modes of executions and these claims.

For example, while the signature comparison step 32 extracts several products as potentially corresponding to the product represented in the zone under analysis, the spatial chromatic histogram comparison step 38 may be replaced by a visual analysis performed by the operator. This is particularly interesting when the list of possible products is short, the operator may rapidly determine the product corresponding to the zone. The step comparison step 32 then acts like a pre-filtering step permitting the operator to work but on a small number of candidates.

One understands that the analytical method may be realized by a computer program product downloaded from a communications network and/or registered on a readable medium by a computer and or executable by a processor.

The photographs of the shelving are presented like data structures representative of the zones of the photograph, each field allowing for the definition of the visual characteristics of the zone adapted for being compared with the signatures of the products in the form of a proximity metric of the visual characteristics of the zone with the signatures of the products.

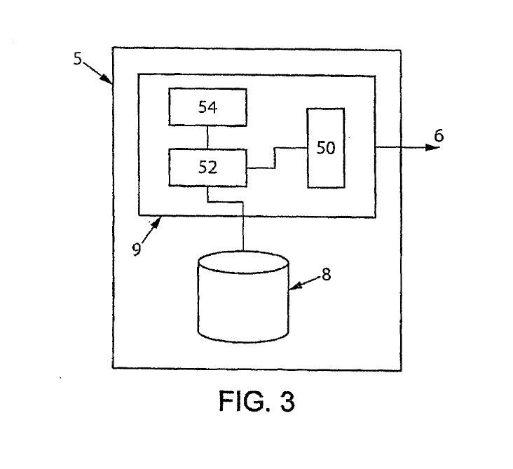

Referring to FIG. 3, a system, such as the server 5 of FIG. 1, analyzes the position of products on the linear of shelves, from a digital photograph or at least a part of the linear of shelving, each product to be analyzed being predefined by a signature of its visual characteristics, consists:
of means 8 of storing the signatures of the said products,
of means 50 for dividing the digital photograph in zones comprising visually identical products, and
for at least one zone,
of means 52 for comparing the visual characteristics of the zone with the signatures of products, the comparison being based on a proximity metric of visual characteristics of the zone with the signatures of the products, and
of means 54 for determining where or of which products appearing in the zone as having a signature minimizing the proximity metric.

1. A method for the analysis of the positioning of products on shelves based on a digital photograph of at least a part of the shelves, each product to be analyzed being predefined by a signature of visual characteristics of the said product, the method comprises the steps of:
a. dividing of the digital photograph in zones comprising visually identical products, and
b. for at least one zone,
i. comparing the visual characteristics of the zone with the signatures of products, the comparison being based on a proximity metric of visual characteristics of the zone with the signatures of products and
ii. determination of the product(s) belonging to the zone are products having a signature minimizing the proximity metric.

2. The method according to claim 1, wherein the signature of a product is a function of at least the global visual characteristics of the said product.

3. The method according to claim 2, wherein the global visual characteristics of the product are represented by a vector of which the components are calculated from discrete signals extracted from the image of the said product.

4. The method according to claim 3, wherein the vector comprises at least the components representative of the chrominance and the image palette histogram of the said product.

5. The method according to claim 1, wherein the step of determining the product comprises among other things, when several products minimize the proximity metric for a zone, one sub step of comparison of the spatial chromatic histogram of the said product having a spatial chromatic histogram which is closest to that of the zone.

6. The method according to claim 5, wherein the spatial chromatic histogram uses a palette of labeled colors.

7. The method according to one of the preceding claims, wherein the list of products to be analysed is stored in a relational database of which an index is comprised of the signature of the products.

8. The computer program product encoded in a computer readable support, wherein the computer program product comprises the program code instructions for implementing the analytical method of claim 1.

9. A data structure representing a photograph wherein the structure comprises data fields representative of the zones of the photograph, each field allowing the definition the visual characteristics of the zone adapted for being compared with the signatures of the products in the form of a proximity metric of the visual characteristics of the zone with the signatures of the products.

10. A system for the analysis of the placement of products on shelves from a digital photo of at least a portion of the shelves, each product to be analysed being predefined by a signature of its visual characteristics, wherein the system comprises:
a. means for storing the signatures of the said products,
b. means for dividing the digital photograph in zones comprising visually identical products, and
c. for at least one zone,
i. means of comparing visual characteristics of the zone with the signatures of products, the comparison being based on a proximity metric of visual characteristics of the zone with the signatures of the products, and
ii. means of determining which of the products appearing in the zone are products having a signature minimizing the proximity metric.
